(19) United States
(12) Patent Application Publication
(10) Pub. No.: US 2018/0118556 A1
(43) Pub. Date: May 3, 2018

(54) PX3 FOR HORSES

(71) Applicant: P3 Athletics Inc. dba PX3 Brain Science, Calgary (CA)

(72) Inventors: Paul Bradley Layzell, Calgary (CA); Russell Tanji, Pearl City, HI (US)

(21) Appl. No.: 15/681,085

(22) Filed: Aug. 18, 2017

Related U.S. Application Data
(60) Provisional application No. 62/377,426, filed on Aug. 19, 2016.

(51) Int. Cl. B68B 1/06; A61D 5/00

(52) U.S. Cl. CPC B68B 1/06; A61D 5/00

(57) ABSTRACT

The present application pertains to a customized orthotic mouthpiece for horses and methods associated with creating and using the customized orthotic mouthpieces. These custom mouthpieces, as opposed to the typical bits generally used, do not restrict or impede movement or position of the horse's tongue. Furthermore, the custom mouthpieces are able to increase the flow of oxygen for the horse to consume compared to typical bits used, thereby enhancing the ability of the horse to function. These custom mouthpieces will prove useful when the horse is involved in competition, training, and recovery. In particular, improvements to the horse's respiratory, physiological, and neurological performance can be seen, especially when the horse is active for long periods of time due to the increased flow of oxygen.

### CROSS-REFERENCE TO RELATED APPLICATIONS

The present application claims the priority benefit of U.S. provisional patent application 62/377,426 filed Aug. 19, 2016, the disclosure of which is incorporated herein by reference.

### BACKGROUND OF THE INVENTION

### Technical Field

The present disclosure generally relates to mouthpieces for horses. More specifically, the present disclosure relates to custom orthotic mouthpieces for horses directed at replacing traditional bridles.

### Description of the Related Art

Bridles are typically equipment used by individuals (e.g., riders, carriage drivers) to direct a horse. Bridles typically include a headstall that holds a bit that goes into the mouth of the horse and the reins that are attached to the bit. The bit is a type of horse tack usually made of metal or a synthetic material. The bit is placed in the mouth of a horse and assists a rider in communicating with the horse. The bit rests on the bars of the horse's mouth in an interdental region where there are no teeth. The reins allow the rider (or driver) to provide subtle commands or cues to the horse (e.g., turn, slow down, speed up, or stop).

However, traditional bits and bridles may significantly impair a horse's ability to breathe in some circumstances, which in turn significantly increases risk of failure, injury, and even death for both the horse and its human riders or drivers. When a horse moves, its muscles contract by converting chemical energy into mechanical energy. For this process to occur, blood must transport oxygen from the lungs of the horse to the muscles (or other body tissues). The more intensely the horse works (e.g., runs, pulls), the more oxygen will be needed in order for the horse to function properly.

Horses generally require a lot of oxygen to function properly. For example, while walking, a horse can consume around one liter (approximately 0.25 gallons) of oxygen a minute. In contrast, while racing, the horse's oxygen consumption can approach sixty liters (approximately 15 gallons) per minute.

Although it may be natural for a horse to race on a track or jump in order to clear obstacles, it is not natural to force the horse to do so while impairing the horse's ability to breathe. Typical bits and bridles use metal rods that crowd the horse's airways. Furthermore, the bits may cause a horse's tongue to contract back into its throat. In some situations, leather straps may be used to further prevent the horse from opening their mouths.

Typical bits—when not properly used—are also known to cause lacerations to the gums, palate, tongue, teeth, and bones of the horse. Furthermore, in many cases, the effects on oxygen deprivation to the horse are overlooked as also potential negative effects on the success and survivability for both the horse and riders/drivers. There is a need for an improved mouthpiece that can be used on horses that enhances the horse's ability to breathe while being guided by an individual.

### SUMMARY OF THE CLAIMED INVENTION

A custom orthotic mouthpiece for a horse is claimed. The custom orthotic mouthpiece includes a first material fitted in a mouth of a horse. In particular, the first material is fitted around the front teeth and molar teeth of the horse. The first material creates a space between the upper and lower teeth of the horse thereby aligning a jaw of the horse to facilitate better oxygen flow. The custom orthotic mouthpiece also includes a second material fitted to a roof of the mouth. Adjustable bit attachments are associated with the second material which allows reins to be connected to the custom orthotic mouthpiece. The adjustable bit attachments also allows position of the reins to be adjusted based on the horse, user/rider and activity being performed.

A method for creating the custom orthotic mouthpiece is also claimed. The method includes locking the mouth of the horse in an open position through the use of an equine dental halter and mouth-speculum. Afterwards, an imprint of the horse's teeth and palate is obtained using a bite plate. The impressions are used to produce the customized orthotic mouthpiece that will subsequently be installed in the horse's mouth.

### BRIEF DESCRIPTION OF THE DRAWINGS

FIG. 1A and FIG. 1B illustrate an exemplary custom orthotic mouthpiece for a horse.

FIG. 2A and FIG. 2B illustrate an exemplary custom orthotic mouthpiece with removable studs.

FIG. 3 illustrates an exemplary custom orthotic mouthpiece with adjustable bit rings.

FIG. 4A and FIG. 4B illustrate a method for creating the custom orthotic mouthpiece for a horse.

FIG. 5 illustrates a method for installing the custom orthotic mouthpiece for use with a horse.

FIG. 6 illustrates a method for removing the custom orthotic mouthpiece for use with a horse.

### DETAILED DESCRIPTION

The present application pertains to a customized orthotic mouthpiece for horses and methods for creating and using the customized orthotic mouthpieces. These custom mouthpieces, as opposed to the typical bits generally used, do not restrict or impeded movement or position of the horse's tongue. Furthermore, the custom mouthpieces are able to increase the flow of oxygen for the horse to breathe. These features, in combination, will enhance the ability of the horse to function and will prove useful when the horse is involved in competition, training, and recovery. Improvements to the horse's respiratory, physiological, and neurological performance can be especially evidence when the horse is active for long periods of time due to the increased flow of oxygen. Furthermore, the custom mouthpiece is desirable for horse owners who want a more humane and comfortable alternative to traditional bridles.

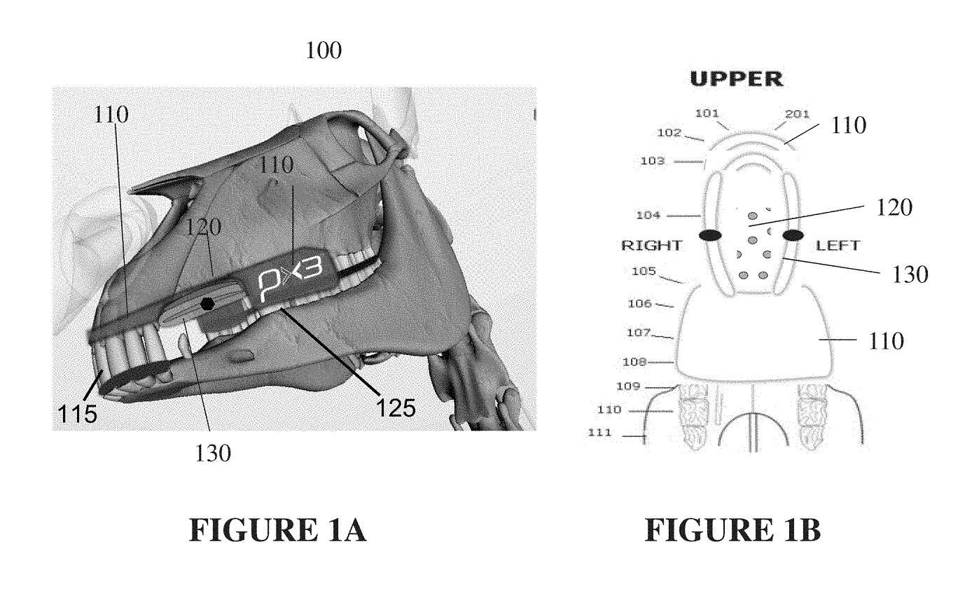

FIG. 1A and FIG. 1B illustrate an exemplary custom orthotic mouthpiece 100 for a horse. In particular, FIG. 1A illustrates an exemplary side view of the custom orthotic mouthpiece 100, and FIG. 1B illustrates an exemplary upper view of the custom orthotic mouthpiece 100. The custom mouthpiece 100 may include three main parts. A first part 110 may be fitted to the premolars 125 and incisors (front teeth) 115 of the horse. The first part 110 may be used to stabilize the lower jaw of the horse while the custom mouthpiece 100 is in use. A second part 120 is a palate piece. The second part 120 when custom-fitted to the roof of the horse's mouth provides the horse with an enhanced ability to breathe when wearing the custom palate piece 120. The third part 130 is an attachment piece for the reins (also referred to herein as an adjustable bit attachment). The third part 130 may be integrated with the second part 120. Further details regarding the three parts of the custom mouthpiece 100 are provided in further detail below. As illustrated, the second part 120 of the custom exemplary orthotic of FIG. 1 is located between a first portion of the first orthotic part 110 that contacts the horses incisors 115 and a second portion of the first part of the orthotic 100 that contacts the horses premolars 125.

The first part 110 of the custom mouthpiece 100 is fitted to the teeth of the horse. In particular, the first part 110 is fitted to the premolars 125 and incisors 115 of the horse. The first part 110 may be made from a variety of soft materials, such as high-strength rubber or thermoplastic reinforced with steel and/or Kevlar. The first part 110 aims to optimize the flow of oxygen for the horse to consume by symmetrically aligning the jaw of the horse. This is especially important in situations where the horse is active for long periods of time.

The second part 120 of the custom mouthpiece 100 is a custom-fit palate portion that is fitted to the roof of the horse's mouth. The second part 120 can be made of a harder material than that of the first part 110. The second part 120 can also have a plurality of removable studs (not shown in FIG. 1) for imparting pressure to the horse's palate. The pressure provided by the studs can be used to direct the horse. In some embodiments, the second part 120 may be made with no studs.

With respect to the second part 120, studs can be added or removed for a variety of reasons. For example, the number of studs and the type of studs may be used based on the type of stimulus response needed, sensitivity of the horse, or the strength of the rider/driver. When studs are capable of being added and removed from the second part 120, the second part may come with a plurality of holes or other physical compartments where studs can be implemented with respect to the second part 120. When studs are not in use, a cover can be provided for each of the holes or physical compartment.

The third part 130 may include adjustable ring attachments for the reins. The third part 130 may be integrated with the second part 120. This allows the reins to be attached to the horse. Where the third part 130 includes the adjustable ring, the reins can be adjusted based on the specific event, action, or horse/rider (driver) combination. For example, if a rider would like an instantaneous response from the horse for performing an action (e.g., jumping), the reins can be adjusted further back towards the rider. However, if the rider (e.g., rancher) plans on riding the horse all day, a less aggressive arrangement where the reins are provided more forward could be used instead.

In some embodiments, the third part 130 may also include one or more sensors usable to collect data about the horse. The sensors may be force sensors and can be situated at or around where the reins are attached. The sensors can be used to collect data regarding how much force a rider provides to the horse's mouth when the rider rides the horse. This information may be helpful in identifying an amount of force that the rider may need to provide in order to obtain a desired response from the horse.

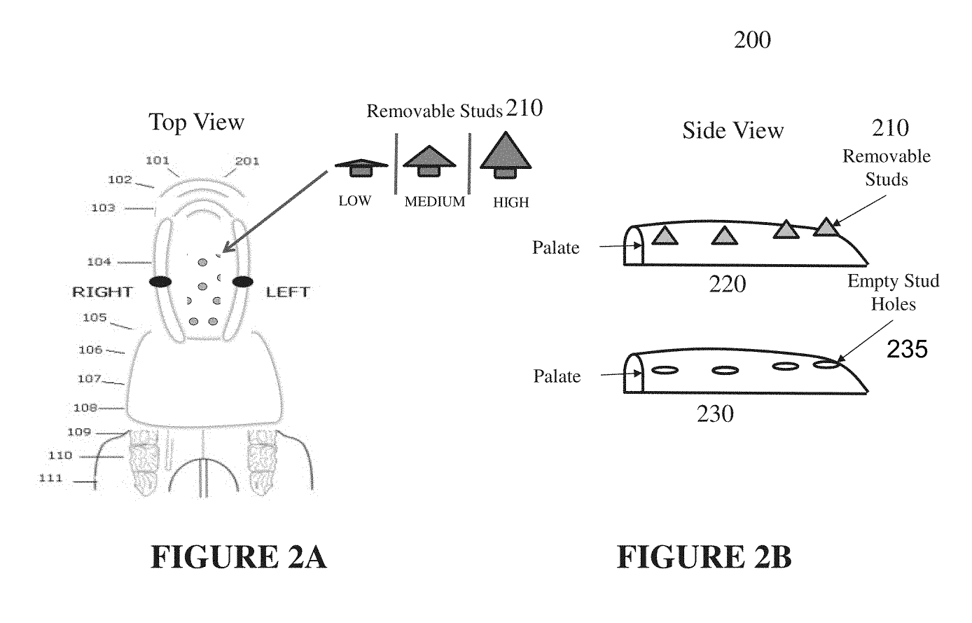

FIG. 2A and FIG. 2B illustrate an exemplary custom orthotic mouthpiece 200 with removable studs. In particular, FIG. 2A illustrates an exemplary top view of the custom orthotic mouthpiece 200 with different types of studs 210 that can be used, and FIG. 2B illustrates exemplary side views of the custom orthotic mouthpiece with 220 and without the removable studs 230. Orthotic mouthpieces 220 and 230 may be fabricated with different lengths, widths, and thicknesses, as such orthotic mouthpieces 220 and 230 form fit to a horse's palate mouth area. In certain instances, the dimensions of an orthotic mouthpiece may be identified by three dimensional computer imaging of the horse's mouth or may be identified by form fitting a mold or mouthpiece part to the horse's mouth.

As noted above, the second part is a custom-fit portion 200/220/230 that fits on the palate/roof of the horse's mouth. In some embodiments, the second part may come with one or more studs 210 attached. The studs 210 may be used to impart pressure to the roof of the horse's mouth and thereby direct the horse based on pressure being applied to the horse's mouth via the studs and via the custom orthotic 220, for example. The studs 210 may be arranged in a variety of different patterns where the chosen pattern may provide different amounts of pressure to the palate/roof of the horse's mouth. In other embodiments, the second part may include a plurality of removable studs 210 that function in the same way except that they may be attached and/or removed from the second part as the user desires.

The removable studs 210 may be removed or added based on the horse and the rider. For example, an increased number of studs 210 can allow for greater pressure to be imparted to the horse when the rider pulls on the reins. The type of studs 210 may also affect the amount of pressure that can be imparted to the horse as well. FIG. 2A includes three different removable studs 210 of different size, where a first size is associated with a lower profile, a second size is associated with a medium profile, and a third size is associated with a higher profiles. Pressures applied for a given amount that the rider pulls the reins will vary based on these profiles. The first size should provide a lower amount of pressure to the horse's palate for a given rider pull, the second size should provide a medium amount of pressure to the horse's palate for that give rider pull, and the third size should provide a higher amount of pressure to the horse's palate for that given rider pull. The pressure is caused, because the reins would drive the second part along with the studs into the roof of the horse's mouth. While FIG. 2A illustrates removable studs that have a pointed upper end, these removable studs may have rounded upper surfaces or be have different shapes. For example, a set of removable studs could have rounded upper surfaces and/or be have an oval shape.

There may be embodiments where fewer studs, or even no studs, would be used. Such embodiments will generally be more comfortable to the horse and may also be appropriate where the rider does not need to impart a lot of pressure for the horse to be directed. Furthermore, in situations where the response from the horse is not needed immediately, fewer or no studs may also be desired.

Each of the removable studs may be attachable to the second part via a plurality of compartments. These compartments may be holes 235 whereby each individual stud 210 can screw or snap into place. Furthermore, when a compartment is not in use by a particular stud, covers (not illustrated) may be provided that screw or snap into place.

As noted above, the shape of the removable stud can vary. Different shapes can be implemented for a variety of different situations. Some shapes (e.g., more or less of an acute or defined edge) may be chosen in order to impart greater or moderated amounts of pressure to the horse's palate. In contrast, more rounded shapes may be chosen when less pressure is desired or when a particular horse displays sensitivity to studs with sharper shapes, for example. In any case, the studs may be made from materials that are designed not to damage the palate/roof of the horse despite providing pressure. FIGS. 2A and 2B illustrate removable studs 210 that provide lower pressure, medium pressures, and higher pressures that correspond to the size or height of a stud.

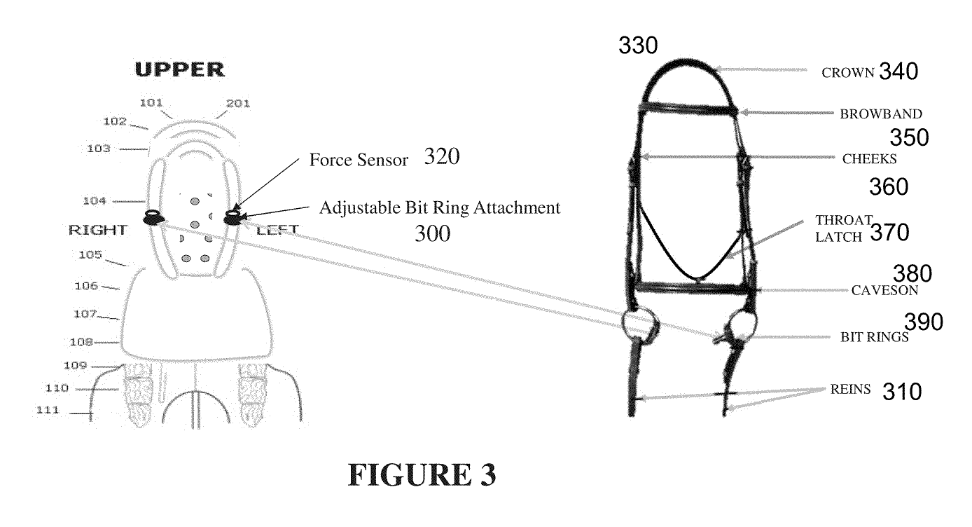

FIG. 3 illustrates an exemplary custom orthotic mouthpiece with adjustable bit rings. The adjustable bit ring attachments 300 are generally attached to the second part.

The adjustable bit ring attachments 300 may be compatible with any standard bridle 330. In particular, the adjustable bit ring attachments 300 provides the rider with the ability to adjust the reins 310 with respect to the horse. As such, a rider may be able to adjust the custom orthotic using the adjustable bit ring when tuning the position of the reins for a specific event or action the horse/rider will perform. This adjustment can be facilitated by adjusting the location where the adjustable bit ring attachments 300 attach to the second part of the mouthpiece. For example, when a rider wishes the horse to perform jumps the adjustable bit ring may be used to move the reins backward or when the rider wishes to ride the horse recreationally, the adjustable bit ring may be moved forward.

There are a variety of different variables as to why and how the reins 310 may be adjusted. For example, variables for how the reins can be attached to the second part may include the height of the hands of the rider (or driver), the size of the horse, the geometry of the horse's head, the rider's riding style, and/or related to a position where the rider sits on the horse. These variables can impact where the reins should be attached to the second part in order to provide the rider with corresponding responsiveness when using the reins.

In a situation, a rancher riding a horse all day may choose a forward mounting point for the reins using the adjustable bit rings attachments 300. Such an arrangement would be less aggressive control and more comfortable for the horse. However, a rider in a jumping competition may need a more instantaneous response from their horse. Therefore, an arrangement where the reins are further back may be desired for more aggressive control.

The adjustable bit ring attachment 300 may be implemented as a slot that is capable of receiving a bit ring associated with reins 310. The bit ring is able to slide along the adjustable bit ring attachment 300, thereby allowing the bit ring (and the attached reins) to be adjusted forwards or backwards along the second part of the orthotic. The adjustment allows the reins to be positioned in a desired location based on the various variables identified above.

Other adjustable bit ring attachments methods may also be used with varying degrees of adjustability. For example, another adjustable bit ring attachment method may instead use several spots along the side of the second part such that the reins may be clipped into instead of the slot. As such, the bit ring attachment 300 may itself attach to one or more spots or slots along a bridle.

Once the bit ring and the reins are situated at a desired location, a locking mechanism locks the reins in that location with respect to the second part. Various locking mechanisms known in the art can be used to prevent the reins from moving, such as twisting locks and lever locks.

In another embodiment, the adjustable bit rings may also have associated sensors 320. In particular, force sensors 320 can be included that are used to collect data regarding how a rider uses the reins. The collected data can monitor and measure an amount of force provided by the rider and correlate it with the type of response the horse provides. In this way, the collected data can be used to 1) inform the rider if the appropriate amount of force is being used to direct the horse in a particular manner and 2) determine if the reins need to be adjusted so that the appropriate force can be provided.

In certain instances, force sensors 320 may be coupled to an electronic device via a wire or via a wireless communication interface. For example, force sensors could be coupled to a cell phone via a Bluetooth wireless communication interface. Sensor data could be provided to the rider dynamically either visually via a display or via an earpiece that provides the rider with audio force measurements in real-time. In instances when wireless sensors are used, a power supply may be integrated into the bridle, reins, and/or the custom orthotic. Such a power supply could include a power extraction unit that couples energy collected from stress forces associated with the bridle, reins, the custom orthotic, or the force sensors themselves. For example, a piezoelectric device or other energy harvesting device (inductive/other) may be used to harvest energy from the horse and/or the rider. In other instances, devices that convert heat or solar energy into electricity may be incorporated into the horses bridle or orthotic. Thermos-electric devices may be use to convert waste heat into electrical energy or a solar cell connected to the bridle may be use to collect energy from available ambient lighting.

Bridle 330 of FIG. 3 includes crown portion 340, a brow band portion 350, a cheek portion 360, a throat latch portion 370, a cave son portion 380, bit rings 390, and reins 310.

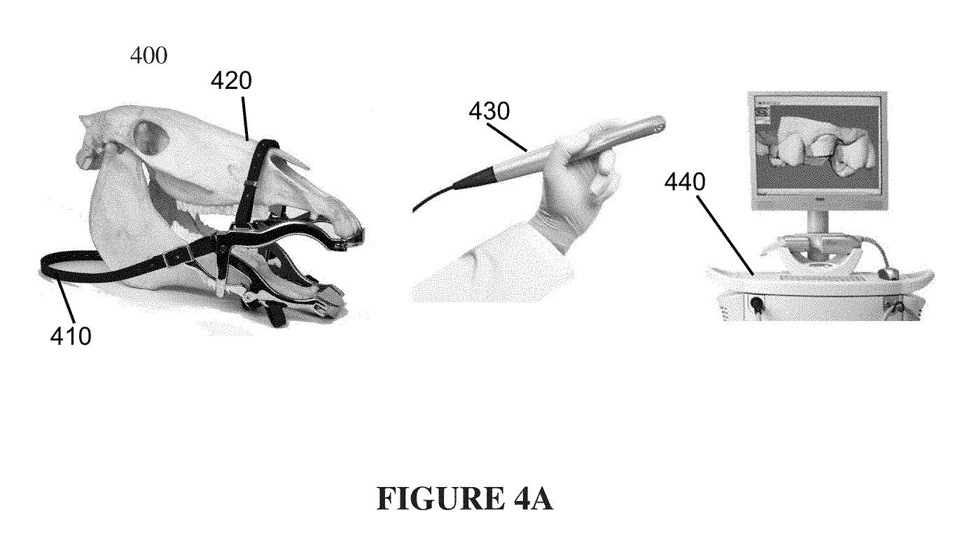

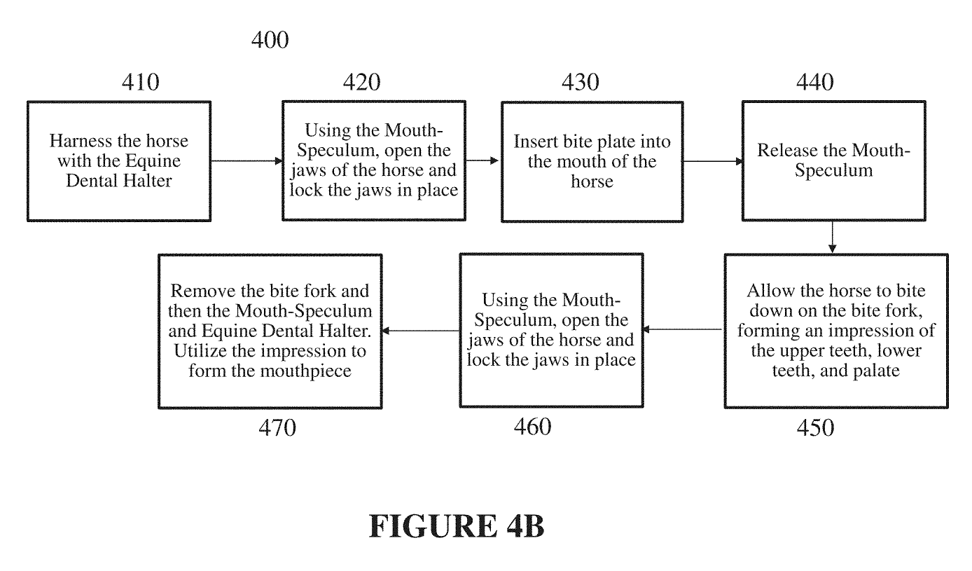

FIG. 4A and FIG. 4B illustrate a method 400 for creating the custom orthotic mouthpiece for a horse. The method may be performed using traditional equine dental speculums (e.g., PX3 digital scanning software) running on a computing device 440, as displayed in FIG. 4A. Equine dental or mouth speculums are used to adjustably open and lock the jaws of a horse in place when performing a procedure on a horse's mouth or teeth. These mouth speculums may be used in conjunction with mouth halters that may be attached to the head of a horse before a mouth speculum is used to open and lock the horse's mouth in place. These mouth speculums may also be used when installing or removing a bridle or custom orthotic from a horse's head 420.

Scanner 430 may be used to scan the teeth, palate and natural resting bite (occlusion) of a horse when collecting data that may be used to produce custom orthotics. In situations where the scanning process is too stressful for the horse, the method may be further facilitated through the use of partial or complete sedation in order to scan the horse's mouth without incident. Method 400 for creating the custom orthotic bridle system 410 may result in an orthotic that fits a horse's head and/or mouth 420 better than conventional methods used to fit bridles to a horse's head and/or mouth. Data derived by scanning the horse's mouth may be manipulated to produce orthotics that have shapes that are different from the scanned data or that are of a different size (width, breadth, or thickness) than a size associated with a raw set of scanned data.

The scanning process, as illustrated in FIG. 4A, may include taking an imprint of the horse's teeth and palate in a similar manner as how such scanning is performed in a human's mouth. For example, a human may use similar technology of a bite plate with impression putty. Granted, the bite plate for the horse may need to accommodate the shape and size of the horse. Furthermore, bite plates may be customized for the various differently-sized horses.

With reference to FIG. 4B, a detailed description of the method 400 for creating the custom orthotic mouthpiece for the horse is provided.

In step 410, the horse is harnessed with an equine dental halter. In step 420, use of a mouth-speculum is implemented so that the horse's mouth can be opened and held in an open position. Once the mouth of the horse is locked in place using the mouth speculum, the bite plate is inserted into the horse's mouth in step 430. The bite plate is used to obtain the impression of the horse's teeth and palate in order to customize the orthotic mouthpiece. In step 440, the mouth speculum is released. In step 450, the horse is able to bite down onto the bite plate. As noted above, the bite plate obtains an impression of the upper teeth, lower teeth and palate for use in customizing the orthotic mouthpiece described above. In such instances, a mold of at least a portion of the horse's mouth may be made from these impressions or an orthotic may be made directly from the impressions. In step 460, the mouth speculum is again used in order to open the mouth of the horse and lock the jaws in place. Finally in step 470, the bite plate is removed along with the equine dental halter and mouth speculum.

In situations where the horse may become stressed during this process, partial or complete sedation may be used so that the bite plate can be inserted without incident. There may also be issues whereby the may have a propensity to grind their teeth that also necessitates the sedation of the horse. The sedation would ensure the integrity of the impression created using the bite plate. If the horse is sedated, the horse's mouth may need to be manually opened and then forced together on the bite plate to form the impression.

Impressions made in steps 410-470 may alternatively be scanned to produce a computerized three dimensional (3D) image that may be used to fabricate a custom orthotic. Here again, the computerized data may be manipulated to produce orthotics that has a shape that is different from the impression or that are of a different size (width, breadth, or thickness) than the impression itself.

Custom orthotics consistent with the present disclosure may also be fabricated from computer data via three dimensional (3D) printing of the custom orthotic. This 3D printing of the orthotics may be facilitated using imaging data derived from scanning the horse's mouth directly or indirectly by scanning the impressions of the horse's mouth.

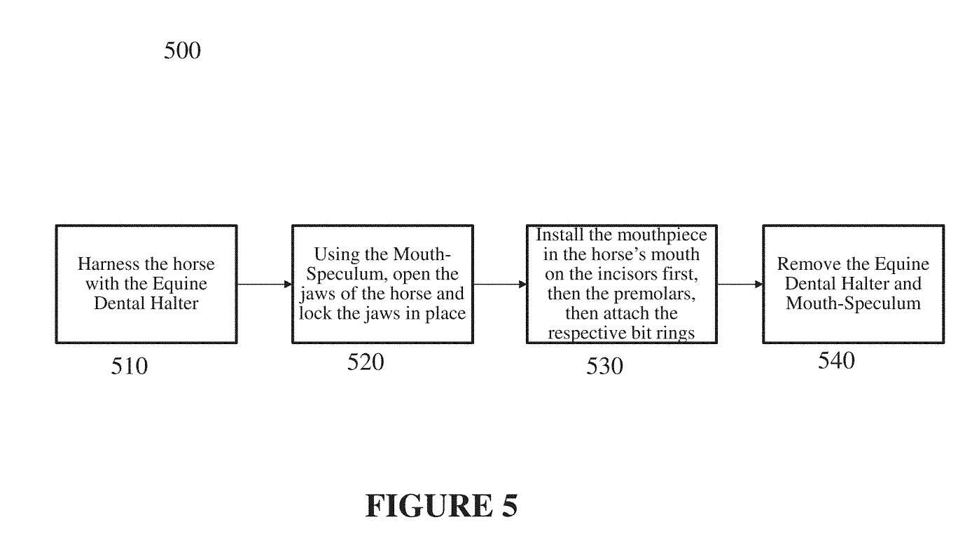

FIG. 5 illustrates a method 500 for installing the custom orthotic mouthpiece for use with a horse. The method 500 for install the custom orthotic mouthpiece is known in the art. In particular, this method 500 also uses the equine dental halters and mouth-speculums as described above in creating the custom orthotic mouthpiece, because it allows the mouth of the horse to be opened and held in place while a person installs the custom orthotic mouthpiece. Step 510 of FIG. 5i s where a horse is harnessed with an equine dental halter, then in step 520 a mouth speculum is used to open and lock the jaws of the horse in place.

Next in step 530, the custom orthotic mouthpiece is installed. Generally, the custom orthotic mouthpiece is installed on the incisors first. Afterwards, the mouthpiece is installed on the premolars. Once the mouthpiece is installed, the ring bit can be attached to the ring bit attachments on the sides of the mouthpiece. After the installation of the custom orthotic mouthpiece is completed, the equine dental halter and mouth-speculum can be removed in step 540.

Similar to the method for creating the custom orthotic mouthpiece, there may be situations where the installation process is too stressful for the horse. Partial or complete sedation can be used to install the custom orthotic mouthpiece without incident. Repeated sedation can be harmful to the horse's health.

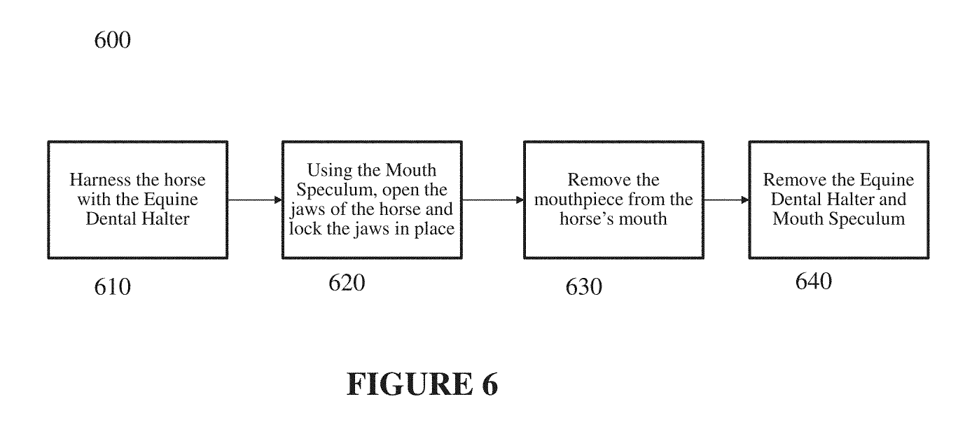

FIG. 6 illustrates a method 600 for removing the custom orthotic mouthpiece for use with a horse. Similar to the method for installing the custom orthotic mouthpiece described in FIG. 5, methods for removing the custom orthotic mouthpiece 600 utilizing equine dental halters and mouth speculum are also known in the art. The equine dental halters and mouth-speculums allow the mouth of the horse to be opened and held in place while a person installs the custom orthotic mouthpiece. Step 610 of FIG. 6 is where a horse is harnessed with an equine dental halter, then in step 620 a mouth speculum is used to open and lock the jaws of the horse in place. Then in step 630, the custom orthotic mouthpiece is removed. Finally, in step 640, the equine dental halter and mouth-speculum can be removed.

Once the custom orthotic mouthpiece has been removed, it is suggested that the mouthpiece should be washed in a cleaning dental solution in order to keep the mouthpiece sanitary. Similarly, partial or complete sedation can be used here if removal of the mouthpiece is too stressful for the horse.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

What is claimed is:

1. A custom orthotic mouthpiece for a horse comprising:
a first portion fitted in a mouth of a horse, wherein the first portion is fitted around front teeth and molar teeth of the horse, and wherein the first portion creates a space between upper and lower teeth of the horse and aligns a jaw of the horse;
a second portion fitted to a roof of the mouth; and
an adjustable bit attachment, wherein the adjustable bit attachment is connected to the second portion, and wherein the adjustable bit attachment is capable of attaching reins to the second portion.

2. The custom orthotic mouthpiece of claim 1, further comprising force sensors that measure a force provided by a rider using reins attached to the second portion, wherein the force sensors are associated with the adjustable rein attachment.

3. The custom orthotic mouthpiece of claim 1, wherein the second portion is smooth against the roof of the mouth of the horse.

4. The custom orthotic mouthpiece of claim 1, wherein the second portion includes a plurality of compartments.

5. The custom orthotic mouthpiece of claim 4, wherein each of the plurality of compartments associated with the second portion can take removable studs.

6. The custom orthotic mouthpiece of claim 5, wherein the removable studs are customizable based on a response desired from the horse.

7. The custom orthotic mouthpiece of claim 5, further comprising one or more covers, wherein each of the plurality of compartments associated with the second portion take one of the covers when removable studs are not associated with a particular compartment.

8. A method of creating a custom orthotic mouthpiece, wherein the method comprises:
locking a mouth of a horse in an open position using an equine dental halter and mouth-speculum;
obtaining an imprint of teeth and palate of the horse, wherein a bite plate is used to obtain an impression of the teeth and palate; and
producing a customized orthotic mouthpiece using the obtained imprint of the teeth and palate, wherein producing the customized orthotic mouthpiece includes:
fitting a first portion in a mouth of a horse, wherein the first portion is fitted around front teeth and molar teeth of the horse, and wherein the first portion creates a space between upper and lower teeth of the horse and aligns a jaw of the horse;
fitting a second portion to a roof of the mouth; and
connecting an adjustable bit attachment to the second portion, wherein
the adjustable bit attachment is capable of attaching reins to the second portion.

9. The method of claim 8, wherein the bite plate further includes putty that facilitates obtaining the impression.

10. The method of claim 8, further comprising sedating the horse.

11. The method of claim 8, wherein the impression of the teeth of the horse includes impression of the upper teeth and the lower teeth.
